(19) United States
(12) Patent Application Publication
(10) Pub. No.: US 2002/0150166 A1
(43) Pub. Date: Oct. 17, 2002

(54) Edge adaptive texture discriminating filtering

(76) Inventor: Andrew W. Johnson, Cupertino, CA (US)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 09/798,009

(22) Filed: Mar. 2, 2001

(51) Int. Cl. H04N 7/12

(52) U.S. Cl. 375/240.29; 375/240.01

(57) ABSTRACT

An apparatus, method, and computer program product for processing a video bitstream includes determining a variance of the variance values for a selected pixel based on a group of pixels in the video bitstream to produce a variance of the variance value for the selected pixel; selecting one of a plurality of filters based on the variance of the variance value for the selected pixel; and applying the selected filter to the selected pixel.

### BACKGROUND

This invention relates to digital video, and more particularly to processing digital video sequences.

Recent advances in computer and networking technology have spurred a dramatic increase in the demand for digital video. One advantage of digital video is that it can be compressed to reduce transmission bandwidth and storage requirements. This process is commonly referred to as “encoding.”

However, the introduction of compression artifacts cannot be avoided when encoding a video sequence at a low bit rate when the video sequence includes high motion and spatial frequency content. One common encoding approach is the coarse quantization of discrete cosine transform (DCT) coefficients. One disadvantage of this approach is the introduction of unwanted, displeasing artifacts.

### SUMMARY

In general, in one aspect, the invention features a method and computer program product for processing a video bitstream. It includes determining a variance of the variance values for a selected pixel based on a group of pixels in the video bitstream to produce a variance of the variance value for the selected pixel; selecting one of a plurality of filters based on the variance of the variance value for the selected pixel; and applying the selected filter to the selected pixel.

Particular implementations can include one or more of the following features. Determining a variance of the variance values includes determining a variance of pixel values for each pixel in a further group of pixels in the video bitstream to produce a variance value for each pixel in the group of pixels. It includes setting to a predetermined value those variance values that fall below a predetermined threshold before determining the variance of the variance values. Determining a variance of pixel values includes determining a sum of absolute differences between the selected pixel and other pixels in the further group. Determining a variance of the variance values further includes determining a sum of absolute differences between a variance value for the selected pixel and the variance values for the other pixels in the group. Selectively applying includes applying a filter to the selected pixel when a condition associated with the selected pixel is satisfied. The filter is a finite impulse response filter. The further group of pixels form a contiguous region in a video image.

Advantages of implementations of the present invention include the following. Implementations of the invention permit the identification of pixel data associated with texture in image structure. Implementations of the invention also permit the preprocessing of data making up a video sequence so as to reduce the spatial frequency content in regions of a video sequence identified as texture. Implementations of the invention also permit the preprocessing of data making up an interlaced video sequence so as to perform adaptive de-interlacing on regions of a video sequence identified as texture.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 depicts a digital video processor receiving a video bitstream.

FIG. 2 is a high-level block diagram of a conventional hybrid differential pulse code modulation (DPCM)/DCT video encoder FIG. 3 is a block diagram of a pre-processor according to one implementation of the present invention.

FIG. 4A depicts a 3×3 pixel data support region for processing field data.

FIG. 4B depicts a 5×3 pixel data support region for processing frame data.

FIG. 5 depicts an example image before pre-processing.

FIG. 6 depicts variance samples for the image of FIG. 5, where the variance estimate samples have been thresholded for display purposes.

FIG. 7 depicts variance of variance samples for the image of FIG. 5, where the variance samples have been thresholded for display purposes.

FIG. 8 depicts another example image for processing.

FIG. 9 depicts variance estimate samples for the image of FIG. 8, where the variance estimate samples have been thresholded for display purposes.

FIG. 10 depicts variance of variance samples for the image of FIG. 8, where the variance samples have been thresholded for display purposes.

FIG. 11 is a block diagram of a filter module according to one implementation of the present invention.

Like reference symbols in the various drawings indicate like elements.

### DETAILED DESCRIPTION

According to one implementation, selective filtering is performed on image structure in the spatial domain (that is, prior to the application of the DCT by the video encoder). This approach reduces the waste in allocating bits to image structure that cannot be encoded well at the desired bit rate (i.e. it is removed or attenuated prior to encoding, rather than by the encoder).

According to one implementation, edge adaptive filtering with texture discrimination is performed on the video data prior to encoding. The input to the filter can be either individual fields, or frames made by merging the top and bottom fields making up a video sequence. For clarity, implementations of the invention are described with reference to processing fields. An interlaced video frame includes two fields of spatial data that are temporally sampled at different locations in time. The interlaced video frame is constructed by interleaving the line data making up two temporally adjacent fields.

The subjective quality of reconstructed video is maximized when the fidelity of encoded edge data associated with picture structure is maximized. However, when coding at low bit rates, maintaining the reconstructed fidelity of textured regions does not provide the same returns, in terms of subjective quality achieved for bits spent. The identification of textured regions and their subsequent filtering prior to encoding can be used to maximize the subjective quality of low bit rate encoded video. This technology extends the useful range of encoded bit rates for a given standard definition television sequence. When implemented to perform field processing, the filtering can be used to reduce the spatial frequency content of regions identified as texture. When implemented to perform frame processing on an interlaced input sequence, application of a vertical low pass filter can be used to perform adaptive de-interlacing on regions identified as texture.

One technique for identifying edge pixels associated with image structure is to use a variance estimate over a pixel region of support. Edge pixels exhibit a higher variance than non-edge pixels.

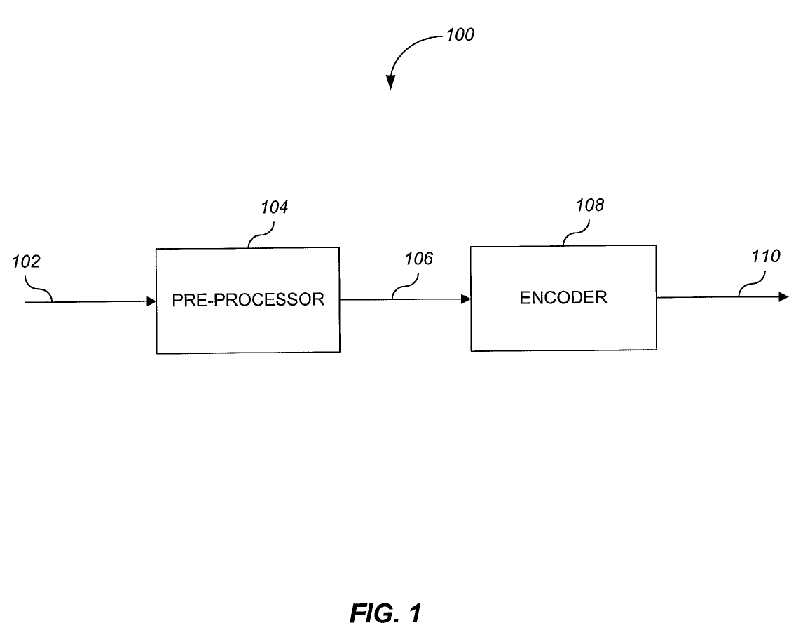

As shown in FIG. 1, a digital video processor 100 receives a video bitstream 102. A pre-processor 104 performs edge adaptive texture discriminating filtering as described in detail below to produce a pre-processed bitstream 106. An encoder 108 encodes the pre-processed bitstream according to conventional methods to produce an output bitstream 110.

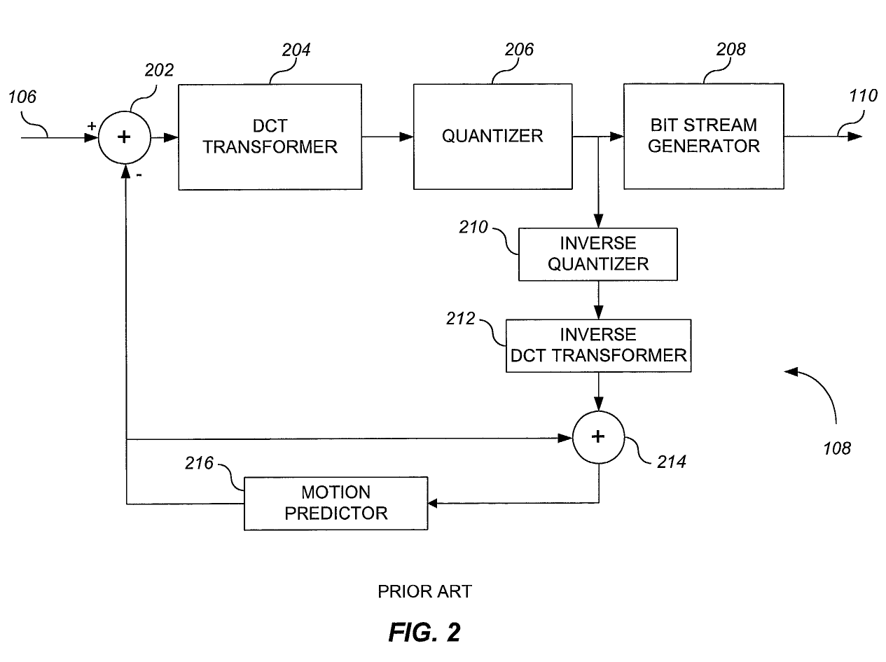

FIG. 2 is a high-level block diagram of a conventional hybrid differential pulse code modulation (DPCM)/DCT video encoder 108. This block-based video encoding architecture employs motion compensation (temporal DPCM) to remove or minimize temporal redundancy and a Discrete Cosine Transform (DCT) to minimize spatial redundancy.

Difference element 202 receives the pre-processed video bit stream 106 and generates a difference signal representing a difference between each input block and a block from a previously encoded and decoded block that has been found to be a close match. The matching operation, generally referred to as “motion estimation,” is performed within motion predictor 216. The block subtraction operation is generally referred to as “motion compensation.”

DCT transformer 204 applies a DCT to the difference signal. The resulting DCT data coefficients are quantized within quantizer 206. The quantized DCT data coefficients are then encoded within bit stream generator 208 to produce output bitstream 110. A decoding operation is employed within inverse quantizer 210 and inverse DCT transformer 212 to reconstruct a block that has been encoded. The operation performed by difference element 202 is reversed by combiner 214, thereby restoring an input block. The restored block is used by the motion predictor to extract motion prediction blocks for use in motion compensation subsequent input blocks.

FIG. 3 is a block diagram of a pre-processor 104 according to one implementation of the present invention. Pre-processor 104 includes two variance modules 304, 308, and a threshold module 306. For each pixel received as part of bitstream 102, a filter select signal 318 is generated and applied to a filter module 310. In response, filter module 310 determines whether any filtering is required for the pixel, and if so, which filter should be applied.

In one implementation, each variance module computes the mathematical variance for each sample according to well-known techniques. In another implementation, each variance module computes an estimate of the variance, referred to herein as a “variance estimate.” The term “variance” is used herein to refer to both the mathematical variance and the variance estimate.

In one implementation, the variance estimate is obtained by computing the Sum of the Absolute Difference (SAD) for each input sample. The SAD is an estimate of the standard deviation for the given support region.. An equation for SAD is given by equation (1), where each pixelᵢ is a pixel in a predetermined support region, average is the average value of the pixels in the region, and N is the number of pixels in the region.

$$S A D = \frac{1}{N} {\sum }_{i ∈ region} \vert {pixel}_{i} - average \vert \qquad ( 1 )$$

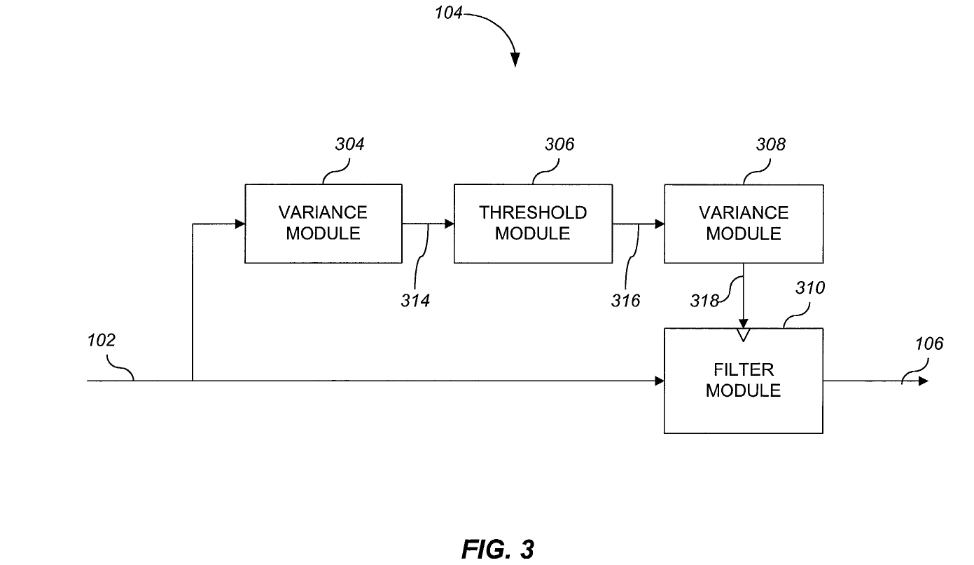

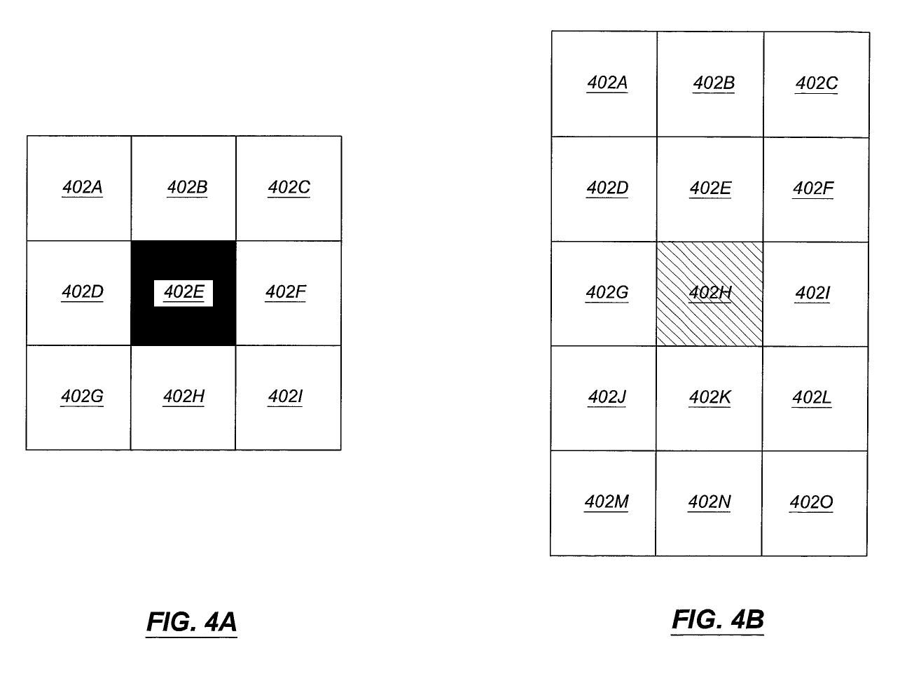

The calculation when processing field data is preferably performed using a 3×3 pixel data support region such as that shown in FIG. 4A. For pixel 402E, the pixel support region comprises the eight surrounding pixels 402A, 402B, 402C, 402D, 402F, 402G, 402H, and 402I. The calculation when processing frame data is preferably performed using a 5×3 pixel data support region such as that shown in FIG. 4B. For pixel 402H, the pixel support region comprises the eight surrounding pixels 402A, 402B, 402C, 402D, 402E, 402F, 402G, 402I, 402J, 402K, 402L, 402M, 402N, and 402O. In one implementation, the pixels in the support region form a contiguous region in a video image.

The SAD variance estimate calculation calculates the average pixel data value average for the 3×3 pixel or 5×3 data support region. The SAD value SAD is the average difference of the support average subtracted from each pixel making up the support region.

Referring again to FIG. 3, variance module 304 receives a bitstream including a plurality of pixels, each having a pixel value. For eight-bit pixels, the pixel values can range from 0-255. Variance module 304 computes a variance value for each pixel in bitstream 302 to produce variance samples 314.

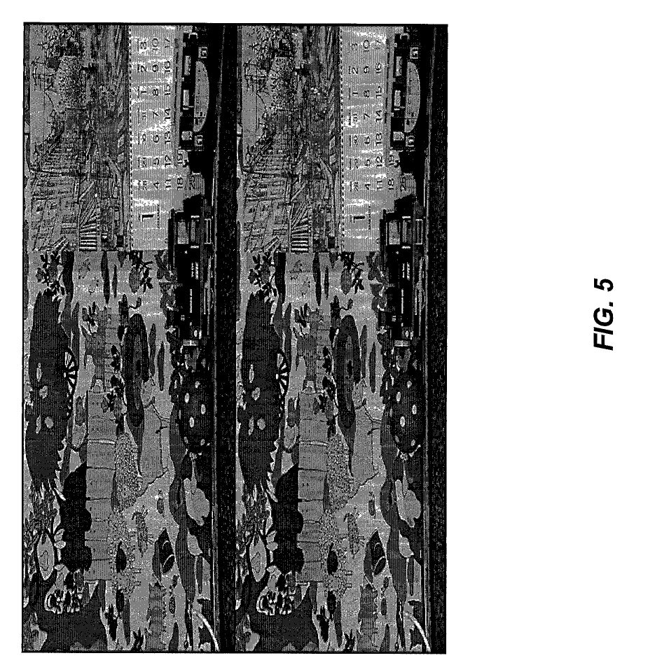

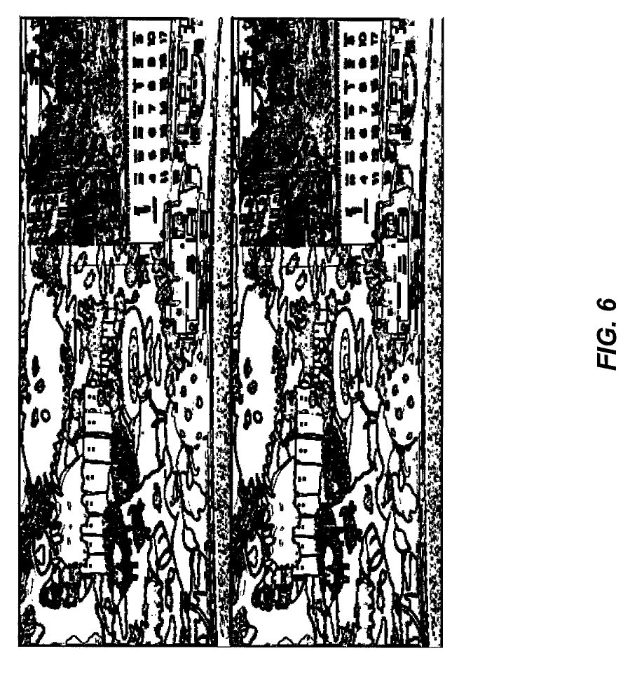

Variance samples 314 are useful in isolating edge regions. FIG. 5 depicts an example image before pre-processing. FIG. 6 depicts variance samples for the image of FIG. 5, where the variance estimate samples have been thresholded for display purposes. The thresholding applied is as follows. A variance estimate value greater than 16 was deemed a hard edge and given a black pixel value. A variance estimate value ranging from 2-16 was deemed a soft edge and given a gray pixel value. A variance estimate value less than 2 was given a white pixel value.

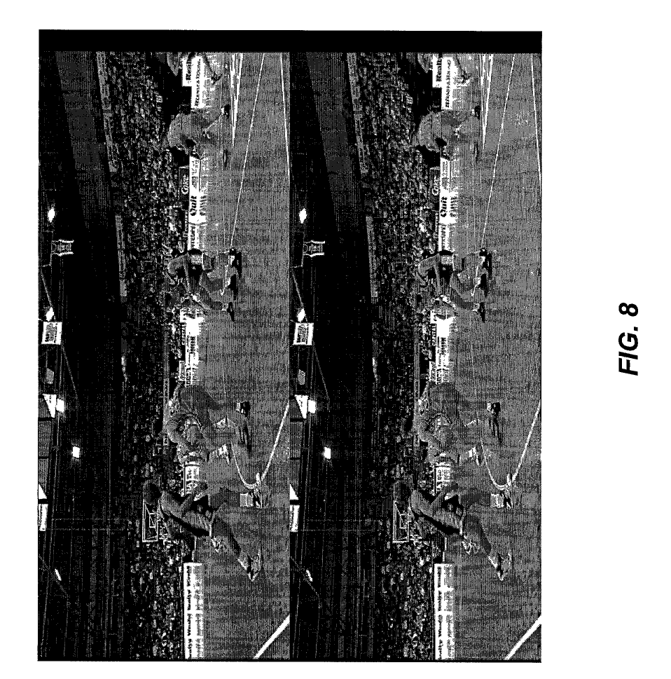

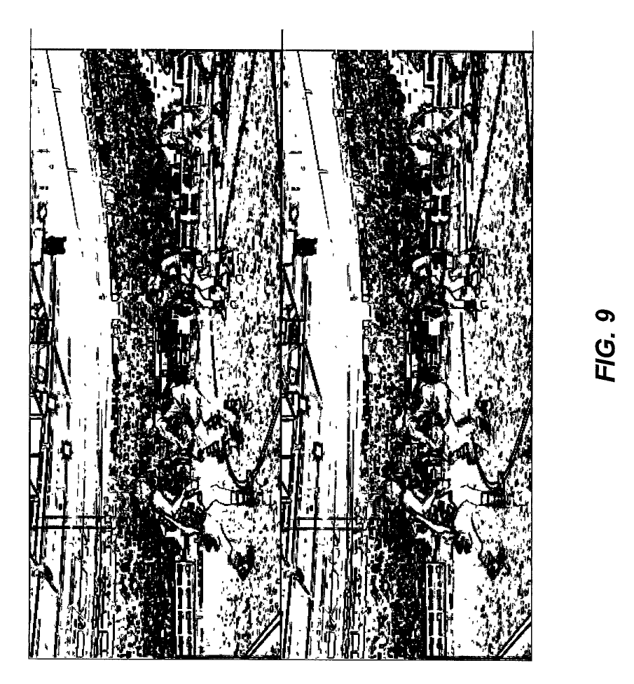

FIG. 8 depicts another example image for processing. FIG. 9 depicts variance estimate samples for the image of FIG. 8, where the variance estimate samples have been thresholded for display purposes. FIGS. 5 and 8 show that a SAD variance estimate offers good performance as an edge detector.

Pixels associated with textured regions can be separated from edge pixels making up the SAD variance estimate figure by calculating the variance estimate of the initial SAD variance estimate. If an edge mass is associated with texture, the variance of the variance of pixel data within an edge mass will be less than the variance of the variance of pixel data located at the border of an edge mass. Pixels bordering a textured region will be identified as edge structure, while pixels contained within the region will be identified as a “flat,” “texture” or an “edge” based upon the variance of the variance statistic. To enhance border processing, the SAD variance estimate data is typically thresholded, and SAD variance estimate values less than the threshold are zeroed prior to being passed to the second SAD variance estimate calculation.

Thresholding module 306 receives variance estimate samples 314 and applies a predetermined thresholding to the values of the variance samples to produce thresholded variance samples 316. In one implementation this is accomplished by setting to a predetermined value those variance estimate values that fall below a predetermined threshold before determining the variance estimate of the variance estimate values. For example, the value of any variance estimate sample 314 having a value less than 14 is set to zero.

Variance module 308 computes a variance value for each thresholded variance estimate sample 316 to produce variance estimate of variance estimate samples 318. The SAD calculation and a 3×3 pixel support region are used when processing either field or field merged frame input sequences..

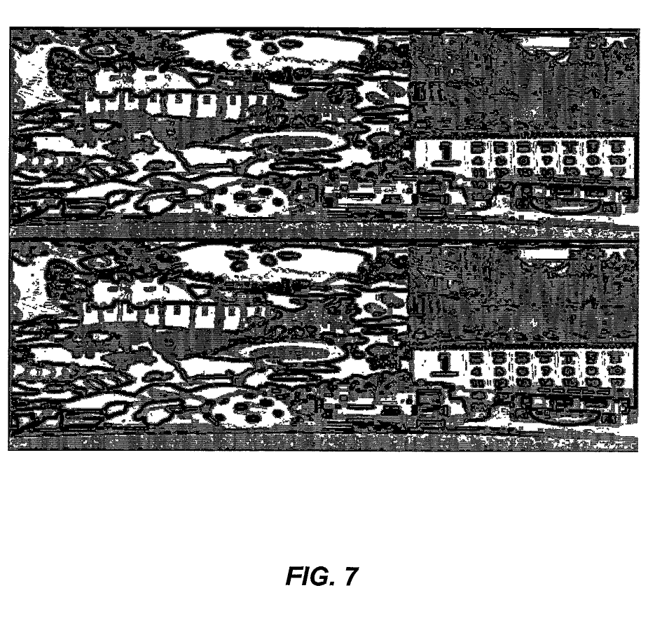

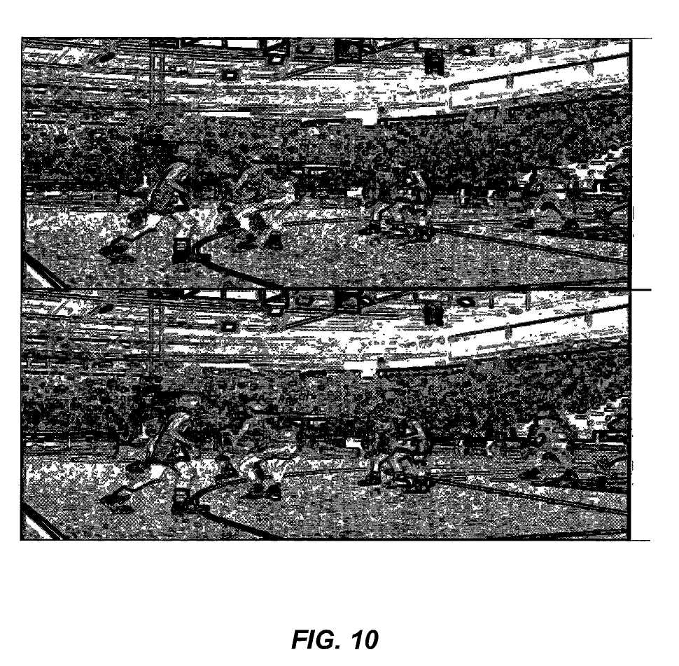

FIG. 7 depicts variance of variance samples for the image of FIG. 5, where the variance samples have been thresholded for display purposes. FIG. 10 depicts variance of variance samples for the image of FIG. 8, where the variance samples have been thresholded for display purposes. The figures are tri-level, with black indicating an edge pixel, gray indicating a texture pixel, and white indicating a DC pixel. Of importance is the fact that textured regions are distinguishable from edge masses. This is clearly evident with the sheep's wool and calendar of FIG. 7, and with the spectators and parquetry floor of FIG. 10.

The variance of the variance values statistic can be used to identify pixels associated with edge structure, texture and DC or flat regions. The variance of the variance value 318 for each pixel making up the image is used to select among a plurality of filters in filter module 310 to process the pixel in both the horizontal and vertical dimensions, thereby producing pre-processed pixels 106.

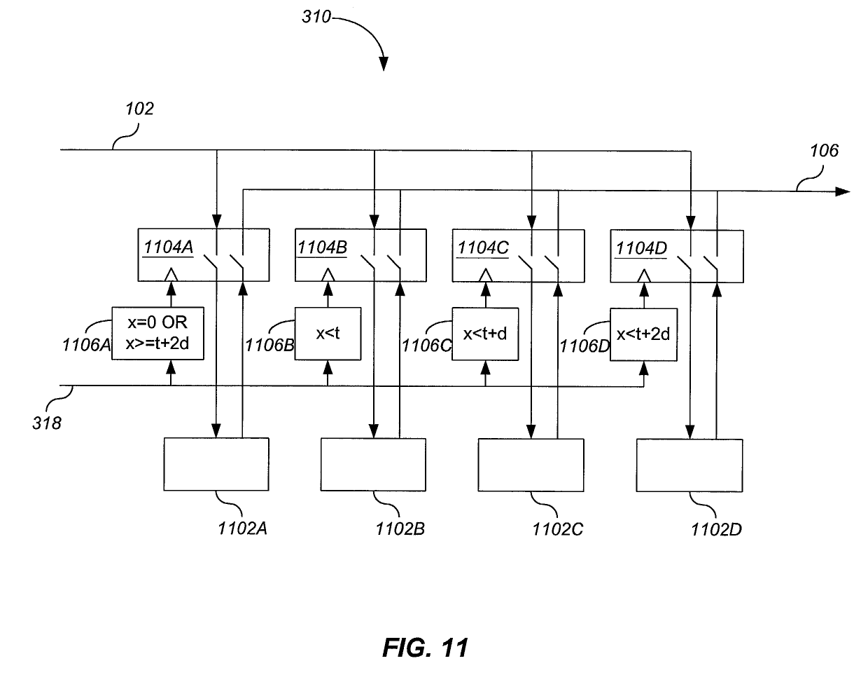

FIG. 11 is a block diagram of filter module 310 according to one implementation of the present invention. Filter module 310 includes filters 1102A, 1102B, 1102C, and 1102D. Each of these filters is a three-tap finite impulse response (FIR) digital filter. The coefficients quantised to 9 bits for FIR filter 1102A are {0, 512, 0}. The coefficients for FIR filter 1102B are { 128 256, 128}. The coefficients for FIR filter 1102C are {52, 410, 52}. The coefficients for FIR filter 1102D are {85, 342, 85}. FIR filters 1102A, 1102B, 1102C, and 1102D are coupled to switches 1104A, 1104B, 1104C, and 1104D, respectively. Switches 1104A, 1104B, 1104C, and 1104D are coupled to triggers 1106A, 1106B, 1106C, and 1106D, respectively. Each trigger receives variance estimate of the variance estimate values 318 and determines whether the received variance estimate of the variance estimate value 318 meets the conditions of the trigger. The conditions for each trigger are given by equations (2), (3), (4), and (5), where x is the variance estimate of variance estimate value and d is a predetermined value. The conditions for trigger 1106A are given by equation (2). The conditions for trigger 1106B are given by equation (3). The conditions for trigger 1106C are given by equation (4). The conditions for trigger 1106D are given by equation (5).

x=0 OR x≧t+2d (2)

x<t (3)

x<t+d (4)

x<t+2d (5)

When a received variance estimate of the variance estimate value 318 meets the conditions of a trigger, the trigger activates the switch to which it is coupled. The activated switch engages the FIR filter to which it is coupled. The engaged FIR filter processes the input bitstream pixel 102 corresponding to the received variance estimate of the variance estimate value 318, thereby producing a pre-processed pixel 106.

This invention can be configured to process field data and field merged frame data. In the former case, only spatial filtering is performed. In the latter case, application of a vertical filter results in both spatial and temporal filtering. In one implementation, the present invention is used to perform adaptive de-interlacing of an interlaced sequence. Areas of an interlaced sequence identified as texture are temporally resampled so that the field data making up a video frame is converted to a progressive frame (that is, so all data in the frame is from the same time location). The de-interlaced/progressive regions are more efficiently coded than their equivalent interlaced counterparts.

Complete de-interlacing of field data is achieved by the application of a half band vertical low pass filter to the field merged frame (for example, such a filter is the three tap { 128, 256, 128}filter). This single spateo-temporal filtering operation is equivalent to performing vertical spatial interpolation on both fields comprising the frame and then temporally averaging the result. Partial de-interlacing is accomplished by the application of a vertical low pass filter that passes more vertical frequency content. The less low pass the vertical filter, the less the de-interlacing that is accomplished by the filtering operation. This implementation of the edge adaptive texture discriminating filter has application when preprocessing interlaced video for subsequent low bit rate encoding. In effect, coding artifacts are exchanged for more pleasing interlace artifacts which are created as a result of displaying progressive material on an interlace monitor/television.

A number of implementations of the invention have been described. Nevertheless, it will be understood that various modifications may be made without departing from the spirit and scope of the invention. For example, the variance estimate statistic is logically coupled with the variance estimate of the variance estimate statistic to provide a finer granularity in the filter selection/control. Filtering may be horizontal only, vertical only or a combination of both horizontal and vertical filtering. Filtering need not be restricted to three taps in length and the coefficient values given. Accordingly, other implementations are within the scope of the following claims.

What is claimed is:

1. An apparatus for processing a video bitstream, comprising:
means for determining a variance of the variance values for a selected pixel based on a group of pixels in the video bitstream to produce a variance of the variance value for the selected pixel;
means for selecting one of a plurality of filters based on the variance of the variance value for the selected pixel; and
means for applying the selected filter to the selected pixel.

2. The apparatus of claim 1, wherein means for determining a variance of the variance values comprises:
means for determining a variance of pixel values for each pixel in a further group of pixels in the video bitstream to produce a variance value for each pixel in the group of pixels.

3. The apparatus of claim 2, further comprising:
means for setting to a predetermined value those variance values that fall below a predetermined threshold before determining the variance of the variance values.

4. The apparatus of claim 2, wherein means for determining a variance of pixel values comprises:
means for determining a sum of absolute differences between the selected pixel and other pixels in the further group.

5. The apparatus of claim 1, wherein means for determining a variance of the variance values further comprises:
means for determining a sum of absolute differences between a variance value for the selected pixel and the variance values for the other pixels in the group.

6. The apparatus of claim 2, wherein means for selectively applying comprises:
means for applying a filter to the selected pixel when a condition associated with the selected pixel is satisfied.

7. The apparatus of claim 6, wherein the filter is a finite impulse response filter.

8. The apparatus of claim 1, wherein the further group of pixels form a contiguous region in a video image.

9. A method for processing a video bitstream, comprising:
determining a variance of the variance values for a selected pixel based on a group of pixels in the video bitstream to produce a variance of the variance value for the selected pixel;
selecting one of a plurality of filters based on the variance of the variance value for the selected pixel; and
applying the selected filter to the selected pixel.

10. The method of claim 1, wherein determining a variance of the variance values comprises:
determining a variance of pixel values for each pixel in a further group of pixels in the video bitstream to produce a variance value for each pixel in the group of pixels.

11. The method of claim 10, further comprising:
setting to a predetermined value those variance values that fall below a predetermined threshold before determining the variance of the variance values.

12. The method of claim 10, wherein determining a variance of pixel values comprises:
determining a sum of absolute differences between the selected pixel and other pixels in the further group.

13. The method of claim 9, wherein determining a variance of the variance values further comprises:
determining a sum of absolute differences between a variance value for the selected pixel and the variance values for the other pixels in the group.

14. The method of claim 10, wherein selectively applying comprises:
applying a filter to the selected pixel when a condition associated with the selected pixel is satisfied.

15. The method of claim 14, wherein the filter is a finite impulse response filter.

16. The method of claim 9, wherein the further group of pixels form a contiguous region in a video image.

17. A computer program product, tangibly stored on a computer-readable medium, for processing a video bitstream, comprising instructions operable to cause a programmable processor to:
determine a variance of the variance values for a selected pixel based on a group of pixels in the video bitstream to produce a variance of the variance value for the selected pixel;
select one of a plurality of filters based on the variance of the variance value for the selected pixel; and
apply the selected filter to the selected pixel.

18. The computer program product of claim 17, wherein instructions operable to cause a programmable processor to determine a variance of the variance values comprise instructions operable to cause a programmable processor to:
determine a variance of pixel values for each pixel in a further group of pixels in the video bitstream to produce a variance value for each pixel in the group of pixels.

19. The computer program product of claim 18, further comprising instructions operable to cause a programmable processor to:
set to a predetermined value those variance values that fall below a predetermined threshold before determining the variance of the variance values.

20. The computer program product of claim 18, wherein instructions operable to cause a programmable processor to determine a variance of pixel values comprise instructions operable to cause a programmable processor to:
determine a sum of absolute differences between the selected pixel and other pixels in the further group.

21. The computer program product of claim 17, wherein instructions operable to cause a programmable processor to determine a variance of the variance values further comprise instructions operable to cause a programmable processor to:
determine a sum of absolute differences between a variance value for the selected pixel and the variance values for the other pixels in the group.

22. The computer program product of claim 18, wherein instructions operable to cause a programmable processor to selectively apply comprise instructions operable to cause a programmable processor to:
apply a filter to the selected pixel when a condition associated with the selected pixel is satisfied.

23. The computer program product of claim 23, wherein the filter is a finite impulse response filter.

24. The computer program product of claim 17, wherein the further group of pixels form a contiguous region in a video image.
